(19) United States
(12) Patent Application Publication
(10) Pub. No.: US 2024/0173669 A1
(43) Pub. Date: May 30, 2024

(54) SEPARATION SYSTEM AND SEPARATION METHOD

(71) Applicants: HONDA MOTOR CO., LTD., Tokyo (JP); NATIONAL UNIVERSITY CORPORATION HOKKAIDO UNIVERSITY, Sapporo-shi (JP)

(72) Inventors: Koichiro Furusawa, Wako-shi (JP); Kazuyuki Takahashi, Wako-shi (JP); Naoki Murata, Wako-shi (JP); Hisayoshi Matsushima, Sapporo-shi (JP); Toranosuke Nago, Sapporo-shi (JP)

(21) Appl. No.: 18/515,315

(22) Filed: Nov. 21, 2023

(30) Foreign Application Priority Data
Nov. 25, 2022 (JP) 2022-188371

(51) Int. Cl. B01D 59/40; B01D 59/42; C25B 1/01; C25B 9/23; C25B 9/70

(52) U.S. Cl. CPC B01D 59/40; B01D 59/42; C25B 1/01; C25B 9/23; C25B 9/70

(57) ABSTRACT

An object of the present invention is to provide a separation system and a separation method that can separate deuterium from a fluid containing light hydrogen and deuterium with high separation efficiency while suppressing equipment deterioration. The present invention provides a separation system including a plurality of separation devices connected in series; each of the plurality of separation devices includes an electrolyte membrane to which an anode catalyst layer and a cathode catalyst layer are provided; a first inflow passage through which a first fluid containing light hydrogen and deuterium flows in, and a first outflow passage through which a second fluid having a lower deuterium content than that of the first fluid flows out are connected to an anode flow passage, a second inflow passage through which a third fluid flows into and a second outflow passage through which a fourth fluid containing light water and heavy water flows out are connected to a cathode flow passage; at least a separation device provided at the most upstream side among the plurality of separation devices is a first separation device into which a gas containing water vapor flows as a third fluid, and from which the third fluid and deuterium that has moved from the anode catalyst layer into the cathode catalyst layer are discharged as the fourth fluid.

### TECHNICAL FIELD

The present invention relates to a separation system and a separation method which separate deuterium from a fluid containing light hydrogen and deuterium.

### BACKGROUND ART

As a technology for concentrating deuterium, which is a hydrogen isotope, a method is known in which a plurality of fuel cells are connected in series, and while generating electricity in each fuel cell, hydrogen isotopes are separated from gas containing hydrogen isotopes and liquid containing hydrogen isotopes is removed (for example, see Patent Document 1).

### PRIOR ART DOCUMENTS

### Patent Documents

Patent Document 1: PCT International Publication No. WO 2018/194182

### SUMMARY OF INVENTION

### Problem to be Solved by the Invention

However, since the method described in Patent Document 1 uses power generation from a plurality of fuel cells, the fuel cells tend to deteriorate. Furthermore, deuterium cannot be efficiently separated from gas containing deuterium, and cannot be as liquid with a high concentration of deuterium.

An object of the present invention is to provide a separation system and a separation method that can separate deuterium from a fluid containing light hydrogen and deuterium with high separation efficiency while suppressing deterioration of the device.

### Means for Solving the Problem

The present invention has the following aspects.

[1] A separation system according to the present invention is a separation system comprising a plurality of separation devices connected in series to separate deuterium from a fluid comprising at least light hydrogen and deuterium, wherein each of the plurality of separation devices comprises an electrolyte membrane having an electrolyte; wherein, of both sides of the electrolyte membrane, an anode catalyst layer and an anode flow passage are provided in this order on a first surface, and a cathode catalyst layer and a cathode flow passage are provided in this order on a second surface; wherein a first inflow passage through which a first fluid that is a gas comprising at least light hydrogen and deuterium flows into the anode flow passage, and a first outflow passage through which a second fluid that is a gas having a lower deuterium content than that of the first fluid flows out from the anode flow passage are connected to the anode flow passage: wherein a second inflow passage through which a third fluid flows into the cathode flow passage and a second outflow passage through which a fourth fluid comprising at least light water and heavy water flows out from the cathode flow passage are connected to the cathode flow passage: and wherein, among the plurality of separation devices, a separation device provided at the most upstream side is a first separation device in which a gas comprising at least water vapor flows into the cathode flow passage as the third fluid, and third fluid that has passed through the cathode flow passage and deuterium that has moved from the anode catalyst layer into the cathode catalyst layer are discharged as the fourth fluid from the cathode flow passage.

According to the separation system above, in the first separation device, by flowing the third fluid, which is a gas containing water vapor instead of oxygen, into the cathode flow passage, the isotope exchange reaction causes HD+H₂O⇔H₂+HDO, and the separation coefficient for separating deuterium is improved. In addition, since the first separation device can separate deuterium without using power generation, consumption of H₂ can be suppressed, and deterioration of the separation system can also be suppressed.

[2] The first separation device may include a humidifier that generates the water vapor.

According to the configuration above, water vapor easily flows into the cathode catalyst layer as the third fluid in the first separation device.

[3] In the first separation device, the third fluid that flows into the cathode flow passage may further contains nitrogen.

According to the configuration above, the isotope exchange reaction occurs more easily and the reaction efficiency increases.

[4] The plurality of separation devices may include one or more of the first separation devices, and one or more second separation devices which are different from the first separation device, and provided downstream of the first separation device, the first separation device may not generate electricity, and the second separation device may generate electricity.

According to the configuration above, the second fluid flowing out from the anode catalyst layer of the first separator can be used for electricity generation in the second separator and can be consumed.

[5] At least one of the plurality of separation devices may further include a circulation means, the circulation means may include a first return flow passage that returns a part of the second fluid flowing out from the anode flow passage into the anode flow passage.

According to the configuration above, the second fluid flowing out from the anode flow passage can be reused, and the second fluid containing deuterium can be used completely.

[6] The plurality of separation devices may include one or more of the first separation devices, and one or more second separation devices which are different from the first separation device, and provided downstream of the first separation device, and an amount of electricity generated in the first separation device may be smaller than an amount of electricity generated in the second separation device.

According to the configuration above, the second fluid flowing out of the anode flow passage of the first separator can be used for electricity generation in the second separator and can be consumed. In addition, since the first separation device also generates a small amount of electricity, the deuterium separation efficiency is further improved.

[7] A separation method according to the present invention is a separation method for separating deuterium from a fluid comprising at least light hydrogen and deuterium using a plurality of separation devices connected in series, wherein each of the plurality of separation devices comprises an electrolyte membrane comprising an electrolyte: wherein, of both sides of the electrolyte membrane, an anode catalyst layer and an anode flow passage are provided in this order on a first side, and a cathode catalyst layer and a cathode flow passage are provided in this order on a second side: wherein a first fluid, which is a gas comprising at least light hydrogen and deuterium, flows into the anode flow passage, and a second fluid, which is a gas having a lower deuterium content than that of the first fluid, flows out from the anode flow passage: wherein a third fluid flows into the cathode flow passage and a fourth fluid comprising at least light water and heavy water flows out from the cathode flow passage; and wherein, among the plurality of separation devices, in a separation device provided at the most upstream side, a gas comprising at least water vapor flows into the cathode flow passage as the third fluid, and third fluid that has passed through the cathode flow passage and deuterium that has moved from the anode catalyst layer into the cathode catalyst layer are discharged as the fourth fluid from the cathode flow passage.

According to the configuration above, in the separation device provided at the most upstream side, by flowing a third fluid, which is a gas containing water vapor instead of oxygen, into the cathode flow passage, the isotope exchange reaction results in HD+H₂O⇔H₂+HDO, and the separation coefficient for separating deuterium is improved. In addition, since the separation device provided at the most upstream side can separate deuterium without using power generation, H₂ consumption can be suppressed and deterioration of the separation system can also be suppressed.

### Effects of the Invention

According to the present invention, it is possible to provide a separation system and a separation method that can separate deuterium from a fluid containing light hydrogen and deuterium with high separation efficiency while suppressing deterioration of the device.

### BRIEF DESCRIPTION OF DRAWINGS

FIG. 1 is a configuration diagram schematically showing an embodiment of a separation system according to the present invention.

FIG. 2 is a configuration diagram schematically showing an embodiment of a first fuel cell provided in a first separation device.

### DETAILED DESCRIPTION OF THE PREFERRED EMBODIMENTS

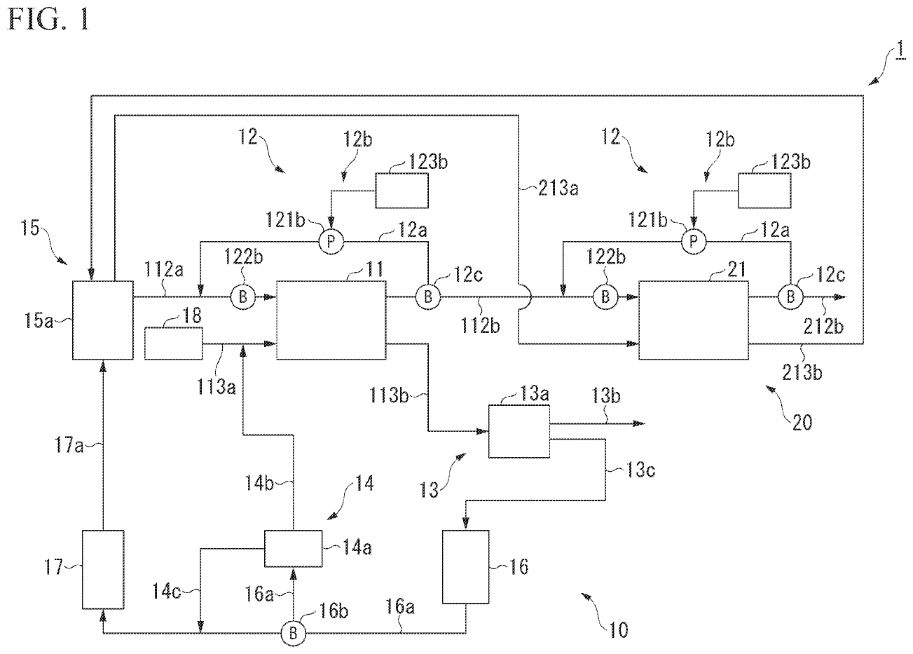

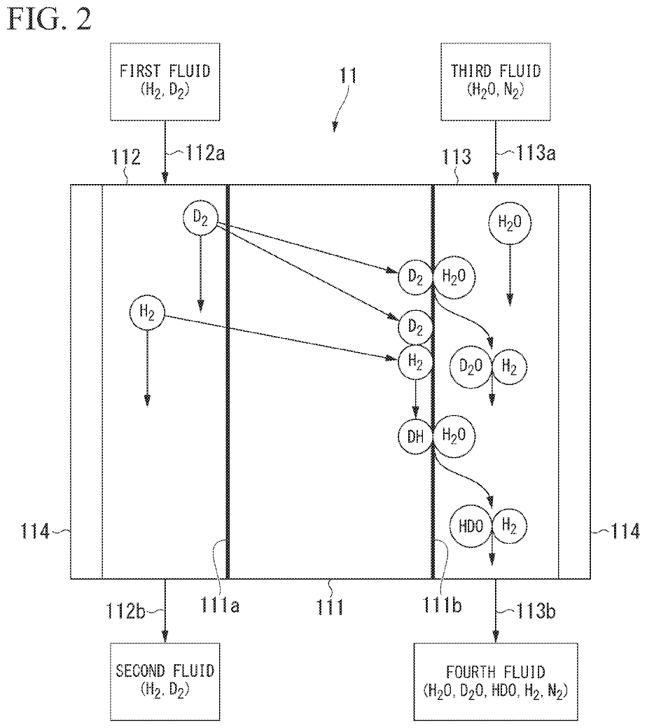

Hereinafter, a separation system and a separation method according to an embodiment of the present invention will be described in detail with reference to FIGS. 1 and 2 as appropriate.

In the present invention, “deuterium” refers to deuterium (2H or D) with a mass number of 2 and tritium (3H or T) with a mass number of 3, among the three isotopes of hydrogen.

In addition, each figure used in the following explanation may show characteristic parts enlarged for convenience in order to make the characteristics easier to understand, and the dimensional ratio and the like of each component may differ from the actual one. Furthermore, although the materials, dimensions, and the like exemplified in the following description are merely examples, the present invention is not limited thereto, and appropriate changes can be made within the scope of the gist thereof.

Furthermore, in FIG. 2, the same components as in FIG. 1 are given the same reference numerals, and their explanations will be omitted.

FIG. 1 is a configuration diagram schematically showing an embodiment of a separation system according to the present invention.

The separation system 1 shown in FIG. 1 includes two separation devices connected in series. In this embodiment, an upstream separation device is a first separation device 10, and a downstream separation device is a second separation device 20. That is, the separation system 1 shown in FIG. 1 includes the first separation device 10 at the most upstream position.

### Separation Device

Each separation device included in the separation system 1 includes an electrolyte membrane containing an electrolyte.

As will be described in detail later, of both surfaces of the electrolyte membrane, an anode catalyst layer and an anode flow passage are provided in this order on a first surface, and a cathode catalyst layer and a cathode flow passage are provided in this order on a second surface.

The anode flow passage is connected to a first inflow passage through which a first fluid that is a gas containing at least light hydrogen and deuterium flows into the anode flow passage, and a first outflow passage through which a second fluid that is a gas having a lower deuterium content than that of the first fluid flows out from the anode flow passage.

On the other hand, the cathode flow passage is connected to a second inflow passage through which a third fluid flows into the cathode flow passage, and a second outflow passage through which a fourth fluid containing at least light hydrogen and deuterium flows out from the cathode flow passage.

In the present invention, a separation device in which a gas containing at least water vapor as the third fluid flows into the cathode flow passage, and in which a third fluid which has passed through the cathode flow passage and deuterium which has moved from the anode catalyst layer into the cathode catalyst layer as the fourth fluid flow out from the cathode flow passage is referred to the “first separation device”. Further, a separation device different from the first separation device is referred to as the “second separation device”.

### First Separation Device

The first separation device 10 shown in FIG. 1 includes a first fuel cell 11, a circulation means 12, a gas-liquid separation means 13, a vaporization means 14, a water electrolysis means 15, and a humidifier 18. The first fuel cell 11 in the present embodiment is connected to the circulation means 12, the gas-liquid separation means 13, the vaporization means 14, the water electrolysis means 15, and the humidifier 18. The gas-liquid separation means 13 is connected to the vaporization means 14 through a first tank 16. The vaporization means 14 is connected to the water electrolysis means 15 through a second tank 17.

### First Fuel Cell

The first fuel cell 11 is for separating deuterium from a fluid containing light hydrogen and deuterium. If the flow of electrons is cut off in the first fuel cell 11, power generation will not occur.

As shown in FIG. 2, for example, the first fuel cell 11 includes an electrolyte membrane 111 including an electrolyte, an anode catalyst layer 111a provided on a first surface and a cathode catalyst layer 111b provided on a second surface of both surfaces of the electrolyte membrane 111, an anode flow passage 112 provided on the surface of the anode catalyst layer 111a opposite to the electrolyte membrane 111, a cathode flow passage 113 provided on the surface of the cathode catalyst layer 111b opposite to the electrolyte membrane 111, and a pair of separators 114 sandwiching the electrolyte membrane 111, the anode catalyst layer 111a, the anode flow passage 112, the cathode catalyst layer 111b, and cathode flow passage 113 therebetween.

The electrolyte membrane 111 includes an electrolyte. Light hydrogen and deuterium diffuse through the electrolyte membrane 111 from the anode catalyst layer 111a into the cathode catalyst layer 111b.

The electrolyte membrane 111 is not particularly limited as long as it includes an electrolyte. However, as the electrolyte membrane 111, a solid polymer membrane is preferable because light hydrogen and deuterium are easily diffused, isotope exchange reactions are more likely to occur at the interface between the electrolyte membrane 111 and the cathode catalyst layer 111b, and the reaction efficiency also increases.

Examples of the solid polymer membrane include proton-conductive solid polymer membranes, and anion-conductive solid polymer membranes.

The anode catalyst layer 111a is provided on the first surface of the electrolyte membrane 111.

Examples of the catalyst contained in the anode catalyst layer 111a include noble metals such as platinum and ruthenium, transition metals such as nickel and cobalt, and alloys and oxides thereof. Among these, platinum is preferable because the isotope substitution reaction (H₂+D₂⇔2DH) easily occurs and the reaction efficiency increases.

The anode flow passage 112 is provided on the surface of the anode catalyst layer 11la opposite to the electrolyte membrane 111. The anode flow passage 112 is a region between the anode catalyst layer 111a and the separator 114.

A first inflow passage 112a and a first outflow passage 112b are connected to the anode flow passage 112. Note that the portion to which the first inflow passage 112a is connected is also referred to as the inlet of the anode catalyst layer 111a, and the portion to which the first outflow passage 112b is connected is also referred to as the outlet of the anode catalyst layer 111a.

The first inflow passage 112a is a pipe for flowing the first fluid, which is a gas containing at least light hydrogen and deuterium, into the anode flow passage 112. Specifically, the first fluid is a gas containing H₂, D₂, and the like.

One end of the first inflow passage 112a in the present embodiment is connected to the anode flow passage 112, and the other end is connected to a water electrolyzer 15a of the water electrolysis means 15, which will be described later.

Note that in the present invention, the first fluid flowing into the anode flow passage 112 in the first separation device 10 is also referred to as “first fluid (1-1).” A part of the first fluid (1-1) passing through the anode flow passage 112 is supplied from the anode flow passage 112 into the anode catalyst layer 111a, and diffuses from the anode catalyst layer 111a into the cathode catalyst layer 111b through the electrolyte membrane 111.

Further, in FIG. 2, tritium is omitted.

The first outflow passage 112b is a pipe for flowing the second fluid, which is a gas having a lower deuterium content than that of the first fluid, out from the anode flow passage 112. Specifically, the second fluid is a gas containing H₂ and D₂, and has a lower content (concentration) of D₂ than that of the first fluid. Further, the second fluid usually has a lower H₂ content (concentration) than that of the first fluid.

The first outflow passage 112b in the present embodiment is connected at one end to the anode flow passage 112, and at the other end to the second fuel cell 21 of the second separation device 20, which will be described later.

Note that in the present invention, the second fluid flowing out from the anode flow passage 112 in the first separation device 10 is also referred to as “second fluid (2-1).”

The cathode catalyst layer 111b is provided on the second surface of the electrolyte membrane 111.

Examples of the catalyst contained in the cathode catalyst layer 111b include noble metals such as platinum and ruthenium, transition metals such as nickel and cobalt, and alloys and oxides thereof. Among these, platinum is preferable because the isotope exchange reaction (HD+H₂O↔H₂+HDO) easily occurs in the cathode catalyst layer 111b and at the interface between the electrolyte membrane 111 and the cathode catalyst layer 111b, and the reaction efficiency increases.

In particular, it is preferable that the electrolyte membrane 111 be a solid polymer membrane and that the anode catalyst layer 111a and the cathode catalyst layer 111b contain platinum, since the isotope exchange reaction is more likely to occur and the reaction efficiency also increases.

The cathode flow passage 113 is provided on the surface of the cathode catalyst layer 111b opposite to the electrolyte membrane 111. The cathode flow passage 113 is a region between cathode catalyst layer 111b and separator 114.

A second inflow passage 113a and a second outflow passage 113b are connected to the cathode flow passage 113. Note that the portion to which the second inflow passage 113a is connected is also referred to as the inlet of the cathode catalyst layer 111b, and the portion to which the second outflow passage 113b is connected is also referred to as the outlet of the cathode catalyst layer 111b.

The second inflow passage 113a is a pipe for flowing the third fluid into the cathode flow passage 113.

In the first separation device 10, a gas containing at least water vapor flows into the cathode flow passage 113 as the third fluid. That is, the third fluid used in the first separation device 10 is specifically a gas containing gaseous H₂O.

The third fluid may further contain a carrier gas as necessary in order to increase the humidity and make it easier for the isotope exchange reaction to occur. Examples of the carrier gas include nitrogen (N₂).

One end of the second inflow passage 113a in the present embodiment is connected to the cathode flow passage 113, and the other end is connected to the humidifier 18, which will be described later.

In the present invention, the third fluid flowing into the cathode flow passage 113 in the first separation device 10 is also referred to as “third fluid (3-1).”

The second outflow passage 113b is a pipe for flowing the fourth fluid containing at least light water and heavy water out from the cathode flow passage 113.

In the first separation device 10, the third fluid (3-1) that has passed through the cathode flow passage 113 and the deuterium that has moved sequentially from the anode flow passage 112 to the anode catalyst layer 111a, the electrolyte membrane 111, the cathode catalyst layer 111b, and cathode flow passage 113 flow out from the cathode flow passage 113 as the fourth fluid. Although details will be described later, the fourth fluid (hereinafter also referred to as “fourth fluid (4-1)”) flowing out from the cathode flow passage 113 in the first separation device 10 is specifically a gas-liquid mixed fluid containing gaseous H₂O and H₂, liquid H₂O (light water), D₂O, HDO (heavy water), and the like. When the third fluid (3-1) contains N₂, the fourth fluid (4-1) also contains N₂.

The second outflow passage 113b in the present embodiment is connected at one end to the cathode flow passage 113, and at the other end to a gas-liquid separator 13a of the gas-liquid separation means 13, which will be described later.

Note that the fourth fluid (4-1) flowing out from the cathode flow passage 113 may be collected as water containing D₂O without connecting the second outflow passage 113b to the gas-liquid separator 13a.

The separators 114 are provided outside the anode flow passage 112 and the cathode flow passage 113, respectively.

Examples of the material of the separators 114 include olefin resins such as polyethylene and polypropylene, and phenol resins.

When one cell (fuel cell) is formed using the electrolyte membrane 111, the anode catalyst layer 111a, the anode flow passage 112, the cathode catalyst layer 111b, the cathode flow passage 113, and the separators 114 are one cell (fuel cell), the first fuel cell 11 may be composed of one fuel cell, or an assembly of a plurality of fuel cells (fuel cell stack).

### Circulation Means

The circulation means 12 is a means for returning a part of the second fluid that has flowed out of the anode flow passage 112 into the anode flow passage 112.

The circulation means 12 in the present embodiment includes a first return flow passage 12a, a flow rate adjustment mechanism 12b, and a first valve 12c.

The first return flow passage 12a is a pipe for returning a part of the second fluid into the anode flow passage 112.

In the circulation means 12 provided in the first separation device 10, one end of the first return flow passage 12a merges with a part of the first outflow passage 112b through the first valve 12c, and the other end merges with a part of the first inflow passage 112a. This allows the second fluid to circulate in the first separation device 10.

The second fluid is a gas having a lower deuterium content than that of the first fluid. Further, the second fluid usually has a lower light hydrogen content than that of the first fluid. It is preferable to add insufficient light hydrogen and deuterium into the second fluid and re-inflow into the anode flow passage 112 of the first fuel cell 11 as the first fluid. As the insufficient light hydrogen and deuterium, for example, light hydrogen and deuterium obtained by electrolyzing water in the water electrolysis means 15 described later may be used.

The flow rate adjustment mechanism 12b adjusts the flow rate of the second fluid before being returned into the anode flow passage 112 to a predetermined value.

The flow rate adjustment mechanism 12b in the present embodiment includes a pump 121b, a second valve 122b, and a flow rate control section 123b.

The pump 121b is provided in a part of the first return flow passage 12a, and is connected to the flow rate control section 123b. Based on the signals from the flow rate control section 123b, the pump 121b can control the flow rate of the second fluid passing through the first return flow passage 12a to a predetermined value.

If the pump 121b has the function of supplying light hydrogen and deuterium, the insufficient light hydrogen and deuterium in the second fluid can be added when the second fluid passes through the pump 121b.

In the circulation means 12 provided in the first separation device 10, the second valve 122b is provided in a part of the first inflow passage 112a. The flow rate of the second fluid can also be adjusted to a predetermined value by opening and closing the second valve 122b.

Here, “adjusting the flow rate of the second fluid to a predetermined value” preferably means adjusting the flow rate of the second fluid returned into the anode flow passage 112 to a flow rate that provides the highest separation efficiency point. The separation efficiency of deuterium tends to increase as the flow rate of the second fluid returned into the anode flow passage 112 increases, but when the flow rate of the second fluid exceeds a certain amount, the separation efficiency tends to decrease. “The flow rate at which the separation efficiency is the highest” is the flow rate of the second fluid when the separation efficiency is the highest.

Note that the first separation device 10 does not need to include the circulation means 12.

### Gas-Liquid Separation Means

The gas-liquid separation means 13 separates the fourth fluid (4-1) flowing out from the cathode flow passage 113 into gas and liquid.

The gas-liquid separation means 13 in the present embodiment includes a gas-liquid separator 13a, a third outflow passage 13b, and a fourth outflow passage 13c.

The gas-liquid separator 13a separates the fourth fluid (4-1) from the fourth fluid (4-1) containing the fourth fluid (4-1).

The gas (4-1-1) contained in the fourth fluid (4-1) is specifically gaseous H₂O, H₂, and N₂. The fourth fluid (4-1-2) after the gas (4-1-1) has been separated contains liquid H₂O, D₂O, and HDO.

The third outflow passage 13b is a pipe through which the gas (4-1-1) (H₂O, H₂, and N₂) separated from the fourth fluid (4-1) flows out from the gas-liquid separator 13a.

The fourth outflow passage 13c is a pipe for flowing out the fourth fluid (4-1-2) (liquid H₂O, D₂O and HDO) from the gas-liquid separator 13a after the gas (4-1-1) has been separated.

The fourth outflow passage 13c in the present embodiment is connected at one end to the gas-liquid separator 13a, and the other end is connected to the first tank 16, which will be described later.

The fourth fluid (4-1-2) after the gas (4-1-1) has been separated may be temporarily stored in the first tank 16.

Note that a fifth outflow passage 16a is connected to the first tank 16.

The fifth outflow passage 16a is a pipe for flowing out the fourth fluid (4-1-2) after the gas (4-1-1) has been separated from the first tank 16.

The fifth outflow passage 16a in the present embodiment is connected at one end to the first tank 16, and the other end is connected to a second tank 17, which will be described later. Furthermore, the fifth outflow passage 16a branches off at a third valve 16b provided at a part thereof.

Note that, the fourth fluid (4-1-2) after the gas (4-1-1) has been separated may be collected as water containing D₂O without connecting the fifth outflow passage 16a to the second tank 17.

Furthermore, the first separation device 10 does not need to include the gas-liquid separation means 13.

### Vaporization Means

The vaporizing means 14 vaporizes the fourth fluid (4-1) flowing out from the cathode flow passage 113.

The vaporizing means 14 in the present embodiment includes a vaporizing section 14a, a second return flow passage 14b, and a sixth outflow passage 14c.

A fifth outflow passage 16a branched off at a third valve 16b is connected to the vaporization section 14a in the present embodiment.

In the vaporization section 14a, the fourth fluid (4-1-2) after the gas (4-1-1) has been separated is vaporized. It is preferable that the vaporization section 14a include a bubbling mechanism. By bubbling, mainly H₂O of the liquid contained in the fourth fluid (4-1-2) is vaporized. As the gas used for bubbling, it is preferable to use N₂.

The second return flow passage 14b is a pipe for flowing out the vaporized fourth fluid (4-1-3) from the vaporization section 14a and returning it into the cathode flow passage 113.

In the present embodiment, the second return flow passage 14b merges with a part of the second inflow passage 113a. As mentioned above, since the vaporized fourth fluid (4-1-3) is mainly H₂O, that is, water vapor, the vaporized fourth fluid (4-1-3) can be re-inflowed as a third fluid (3-1) from the second inflow passage 113a into the cathode flow passage. Note that when N₂ is used when vaporizing the fourth fluid (4-1-2) by bubbling, the fourth fluid (4-1-3) containing water vapor and N₂ can be re-inflowed into the cathode flow passage 113 as the third fluid (3-1).

The sixth outflow passage 14c is a pipe for flowing the unvaporized fourth fluid (4-1-4) out from the vaporization section 14a.

Although the sixth outflow passage 14c in the present embodiment merges with the fifth outflow passage 16a on the downstream side of the third valve 16b, the sixth outflow passage 14c may be directly connected to the second tank 17, which will be described later. In addition, the unvaporized fourth fluid (4-1-4) may be collected as water containing D₂O without merging the sixth outflow passage 14c with the fifth outflow passage 16a or connecting the sixth outflow passage 14c to the second tank 17.

Note that the first separation device 10 does not need to include the vaporization means 14.

### Water Electrolysis Means

The water electrolysis means 15 electrolyzes water.

The water electrolysis means 15 has a water electrolyzer 15a.

As the water electrolyzer 15a, a well-known water electrolyzer can be used, such as a solid polymer type water electrolyzer, an alkaline type water electrolyzer, and the like. Among these, an alkaline water electrolyzer is preferable because it can generate a large amount of hydrogen gas.

The water electrolyzed in the water electrolyzer 15a is not particularly limited. Further, as the water electrolyzed in the water electrolyzer 15a, the fourth fluid (4-1) flowing out from the cathode flow passage 113 may be used as it is, the fourth fluid (4-1-2) obtained by gas-liquid separation of the fourth fluid (4-1) may be used, or the fourth fluid (4-1-4) (D₂O and HDO) that remained as a liquid when the fourth fluid (4-1-2) was vaporized, that is, did not vaporize, may be used.

The water electrolyzed in the water electrolyzer 15a may be temporarily stored in the second tank 17. A fifth outflow passage 16a and a seventh outflow passage 17a are connected to the second tank 17. The seventh outflow passage 17a is a pipe for flowing out water from the second tank 17, and is also connected to the water electrolyzer 15a.

### Humidifier

The humidifier 18 generates water vapor. The water vapor generated in the humidifier 18 flows into the cathode flow passage 113 as the third fluid (3-1) through the second inflow passage 113a. In the present embodiment, the water vapor generated in the humidifier 18 is mixed with the water vapor generated in the vaporization means 14 in the second inflow passage 113a, and then flows into the cathode flow passage 113.

The humidifier 18 is not particularly limited as long as it can generate water vapor.

Note that the first separation device 10 does not need to include the humidifier 18. Moreover, although the first separation device 10 shown in figures includes a vaporizing means 14 and a humidifier 18 separately, the vaporizing means 14 may be used as a humidifier.

### Second Separation Device

The second separation device 20 is a separation device which is different from the first separation device 10 and provided downstream of the first separation device 10.

The second separation device 20 generates power using hydrogen and oxygen. That is, the separation system 1 shown in FIG. 1 is also a separation/power generation system.

The second separation device 20 in the present embodiment includes a second fuel cell 21 and a circulation means 12.

### Second Fuel Cell

The second fuel cell 21 generates water while generating electricity using a fluid containing light hydrogen and deuterium. During power generation, deuterium is separated from a fluid containing light hydrogen and deuterium.

The second fuel cell 21 includes an electrolyte membrane containing an electrolyte, an anode catalyst layer provided on a first surface and a cathode catalyst layer provided on a second surface of both surfaces of the electrolyte membrane, an anode flow passage provided on the surface of the cathode catalyst layer opposite to the electrolyte membrane, a cathode flow passage provided on the surface of the cathode catalyst layer opposite to the electrolyte membrane, and a pair of separators sandwiching the electrolyte membrane, the anode catalyst layer, the anode flow passage, the cathode catalyst layer, and the cathode flow passage therebetween.

The electrolyte membrane, anode catalyst layer, anode flow passage, cathode catalyst layer, the cathode flow passage, and separators that constitute the second fuel cell 21 may respectively be the same as the electrolyte membrane 111, the anode catalyst layer 111a, the anode flow passage 112, the cathode catalyst layer 111b, the cathode flow passage 113, and the separators 114 that constitute the first fuel cell 11 provided in the first separation device 10.

The second fuel cell 21 may be composed of one fuel cell, or may be an assembly (fuel cell stack) of a plurality of fuel cells.

The first outflow passage 112b of the first fuel cell 11 is connected to the anode flow passage of the second fuel cell 21, the second fluid (2-1) can be flowed into the anode flow passage of the second fuel cell 21, and the second fluid (2-1) is used for power generation and consumed.

Note that in the present embodiment, the second fluid (2-1) is also the first fluid that flows into the anode flow passage of the second fuel cell 21. Furthermore, the first outflow passage 112b that flows out the second fluid (2-1) from the anode flow passage 112 of the first fuel cell 11 is also the first inflow passage for flowing the first fluid into the anode flow passage of the second fuel cell 21.

Further, in the present invention, the first fluid flowing into the anode flow passage in the second separation device 20 is also referred to as “first fluid (1-2).” That is, as described above, the second fluid (2-1) is also the first fluid (1-2).

Furthermore, a first outflow passage 212b is connected to the anode flow passage of the second fuel cell 21.

The first outflow passage 212b is a pipe for flowing the second fluid, which has not been used for power generation, and is a gas with a lower deuterium content than that of the first fluid (1-2), out from the anode flow passage of the second fuel cell 21.

In the present invention, the second fluid flowing out from the anode flow passage in the second separation device 20 is also referred to as “second fluid (2-2).”

A second inflow passage 213a and a second outflow passage 213b are connected to the cathode flow passage of the second fuel cell 21.

The second inflow passage 213a is a pipe for flowing the third fluid into the cathode flow passage of the second fuel cell 21.

In the second separation device 20, oxygen flows into the cathode flow passage as a third fluid. That is, the third fluid used in the second separation device 20 is specifically oxygen.

The second inflow passage 213a in the present embodiment is connected at one end of the cathode flow passage of the second fuel cell 21 and at the other end to the water electrolyzer 15a of the water electrolysis means 15. The oxygen generated in the water electrolysis means 15 can be flowed into the cathode flow passage of the second fuel cell 21.

Note that in the present invention, the third fluid flowing into the cathode flow passage in the second separation device 20 is also referred to as “third fluid (3-2).”

The second outflow passage 213b is a pipe for flowing out a fourth fluid containing at least light water and heavy water from the cathode flow passage.

In the second separation device 20, the water (H₂O and D₂O) produced in the second fuel cell 21 flows out as the fourth fluid from the cathode flow passage of the second fuel cell 21.

The second outflow passage 213b in the present embodiment is connected at one end to the cathode flow passage of the second fuel cell 21, and at the other end to the water electrolyzer 15a of the water electrolysis means 15. Thereby, the fourth fluid, which is water (H₂O and D₂O) produced in the second fuel cell 21, can be electrolyzed and reused. However, the water (H₂O and D₂O) produced in the second fuel cell 21 may be discharged without being reused.

Note that in the present invention, the fourth fluid flowing out from the cathode flow passage in the second separation device 20 is also referred to as “fourth fluid (4-2).”

### Circulation Means

The circulation means 12 provided in the second separation device 20 has the same configuration as that of the circulation device 12 provided in the first separation device 10 except for the following (i) to (iii). Accordingly, components having the same configuration are given the same reference numerals, and their explanations will be omitted.

(i) In the circulation means 12 provided in the first separation device 10, the first valve 12c is provided in a part of the first outflow passage 112b, whereas in the circulation means 12 provided in the second separation device 20, the first valve 12c is provided in a part of the first outflow passage 212b.

(ii) In the circulation means 12 provided in the first separation device 10, the second valve 122b is provided in a part of the first inflow passage 112a, whereas in the circulation means 12 provided in the second separation device 20, the second valve 122b is provided in a part of the first outflow passage 112b.

(iii) In the circulation means 12 provided in the first separation device 10, one end of the first return flow passage 12a merges with a part of the first outflow passage 112b through the first valve 12c, and the other end merges with a part of the first inflow passage 112a. In contrast, in the circulation means 12 provided in the second separation device 20, one end of the first return flow passage 12a merges with a part of the first outflow passage 212b through the first valve 12c, and the other end merges with a part of the first outflow passage 112b.

Note that the second separation device 20 does not need to include the circulation means 12.

### Separation Method

Hereinafter, a separation method according to an embodiment of the present invention will be explained. Note that the separation method described below is an example of a separation method using the separation system 1 shown in FIG. 1.

### Separation in the First Separation Device

First, the water electrolysis means 15 electrolyzes water, such as water containing deuterium, for example. Among the gases obtained by the electrolysis, the first fluid (1-1), which is a gas containing light hydrogen and deuterium, flows into the anode flow passage 112 of the first fuel cell 11 through the first inflow passage 112a.

Separately, the third fluid (3-1) containing water vapor generated in the humidifier 18 and N₂ as necessary flows into the cathode flow passage 113 of the first fuel cell 11 through the second inflow passage 113a.

As shown in FIG. 2, a part of light hydrogen (H₂) and deuterium (D₂) contained in the first fluid (1-1) that has flowed into the anode flow passage 112 moves from the anode flow passage 112 into the anode catalyst layer 111a, further passes through the electrolyte membrane 111 from the anode catalyst layer 111a and moves to the cathode catalyst layer 111b.

Light hydrogen (H2) and deuterium (D2) that have moved into the cathode catalyst layer 111b undergo an isotope exchange reaction with water vapor (H₂O) contained in the third fluid (3-1) that has moved from the cathode flow passage 113 into the cathode catalyst layer 111b, and produce D₂O and HDO in the cathode catalyst layer 111b and at the interface between the electrolyte membrane 111 and the cathode catalyst layer 111b.

Note that the deuterium of the D₂O and HDO is the deuterium that has moved from the anode catalyst layer 111a into the cathode catalyst layer 111b.

Light hydrogen (H2) and deuterium (D2) contained in the first fluid (1-1) that have not moved into the cathode catalyst layer 111b are discharged as the second fluid (2-1) with a lower deuterium content than that of the first fluid (1-1) from the anode flow passage 112 through the first outflow passage 112b.

A part of the second fluid (2-1) flowing out from the anode flow passage 112 of the first fuel cell 11 may be returned into the anode flow passage 112 of the first fuel cell 11 by the circulation means 12 provided in the first separation device 10. Specifically, a part of the second fluid (2-1) is supplied into the first return flow passage 12a by adjusting the first valve 12c such that the first outflow passage 112b is connected to the first return flow passage 12a. At this time, the opening and closing of the first valve 12c is adjusted such that the remaining second fluid (2-1) is supplied into the second separation device 20. In addition, it is preferable that the pressure of the pump 121b of the flow rate adjustment mechanism 12b and the opening and closing of the second valve 122b be adjusted such that the flow rate of the second fluid (2-1) before being returned into the anode flow passage 112 of the first fuel cell 11 is a predetermined flow rate, preferably a flow rate that provides the highest separation efficiency.

The second fluid (2-1) that has passed through the first return flow passage 12a is supplied into the first inflow passage 112a. The second fluid (2-1) has a lower deuterium content and light hydrogen content than those of the first fluid (1-1). Therefore, it is preferable that an insufficient amount of light hydrogen and deuterium be added into the second fluid (2-1) and re-inflowed as the first fluid (1-1) from the first inflow passage 112a into the anode flow passage 112 of the first fuel cell 11. As the insufficient light hydrogen and deuterium, for example, light hydrogen and deuterium obtained by electrolyzing water in the water electrolysis means 15 can be used. Furthermore, if the pump 121b has a function of supplying light hydrogen and deuterium, the insufficient light hydrogen and deuterium can be added into the second fluid (2-1) when the second fluid (2-1) passes through the pump 121b.

By returning a part of the second fluid (2-1) that has flowed out from the anode flow passage of the first fuel cell 11 into the anode flow passage 112 of the first fuel cell 11, the gas that has flowed out from the anode flow passage 112 can be recycled, and gas containing deuterium can be used completely. In particular, if the flow rate of the second fluid (2-1) before being returned into the anode flow passage 112 of the first fuel cell 11 is adjusted to a predetermined value, the separation coefficient for separating deuterium can be further improved.

A part of the second fluid (2-1) flowing out from the anode flow passage 112 of the first fuel cell 11 may be returned into the anode flow passage 112 of the first fuel cell 11, or all of it may be returned into the anode flow passage 112 of the first fuel cell 11. If all of the second fluid is used for power generation, light hydrogen (H₂) and deuterium (D₂) contained in the second fluid (2-1) can be consumed.

The third fluid (3-1) that passes through the cathode flow passage 113 of the first fuel cell 11 without being used in the isotope exchange reaction, and D₂O, HDO, and H₂ that have been generated by the isotope exchange reaction and moved into the cathode flow passage 113 are discharged as the fourth fluid (4-1) from the cathode flow passage of the first fuel cell 11 through the second outflow passage 113b. That is, the fourth fluid (4-1) is specifically a gas-liquid mixed fluid containing gaseous H₂O and H₂, and liquid H₂O, D2O, and HDO. When the third fluid (3-1) contains N₂, the fourth fluid (4-1) also contains N₂.

The fourth fluid (4-1) flowing out from the cathode flow passage 113 of the first fuel cell 11 may be separated into gas and liquid in the gas-liquid separator 13a of the gas-liquid separation means 13, or may be collected as water containing D₂O, and collected.

When the fourth fluid (4-1) is subjected to gas-liquid separation, the gas (4-1-1) (H₂O, H₂ and N₂) which has been separated from the fourth fluid (4-1) is flowed out from the gas-liquid separator 13a through the third outflow passage 13b, and discharged.

The fourth fluid (4-1-2)(liquid H₂O, D₂O and HDO) after the gas (4-1-1) has been separated from the fourth fluid (4-1) is flowed out from the gas-liquid separator 13a through the fourth outflow passage 13c.

The fourth fluid (4-1-2) after the gas (4-1-1) has been separated from the fourth fluid (4-1) in the gas-liquid separation means 13 may be stored in the first tank 16 as necessary and then supplied into the vaporization means 14 or stored in the first tank 16 and the second tank 17 as necessary and then supplied into the water electrolysis means 15. Further, the fourth fluid (4-1-2) after the gas (4-1-1) has been separated from the fourth fluid (4-1) in the gas-liquid separation means 13 may be collected as water containing D₂O.

The destination of the fourth fluid (4-1-2) after the gas (4-1-1) has been separated from the fourth fluid (4-1) in the gas-liquid separation means 13 can be controlled by the third valve 16b.

When the fourth fluid (4-1-2) after the gas (4-1-1) has been separated from the fourth fluid (4-1) in the gas-liquid separation means 13 is supplied into the vaporization means 14, the fourth fluid (4-1-2) is vaporized in the vaporization section 14a. At this time, it is preferable to vaporize the fourth fluid (4-1-2) by bubbling with N₂.

By vaporizing the fourth fluid (4-1-2), liquid H₂O contained in the fourth fluid (4-1-2) is mainly vaporized and becomes water vapor.

The fourth fluid (4-1-3) vaporized in the vaporization means 14 may flow out from the vaporization section 14a through the second return flow passage 14b and may be returned into the cathode flow passage 113 of the first fuel cell 11. The fourth fluid (4-1-3) that has passed through the second return flow passage 14b is supplied into the second inflow passage 113a, mixed with water vapor generated in the humidifier 18, and then re-inflowed as the third fluid (3-1) from the second inflow passage 113a into the cathode flow passage 113 of the first fuel cell 11. As a result, new fourth fluid (4-1) flows out from the cathode flow passage 113 of the first fuel cell 11. By adding the new fourth fluid (4-1) into the original fourth fluid (4-1), H₂O is reduced in the original fourth fluid (4-1) and new H₂O and D₂O are added. Accordingly, the fourth fluid (4-1) containing deuterium with a higher concentration than the that of the original fourth fluid (4-1) is obtained.

The fourth fluid (4-1-4) that has not been vaporized in the vaporization means 14 may flow out from the vaporization section 14a through the sixth outflow passage 14c, pass through the fifth outflow passage 16a, be stored in the second tank 17 as necessary, and then supplied into the water electrolysis means 15. Further, the fourth fluid (4-1-4) that has not vaporized in the vaporization means 14 may be collected as water containing D₂O.

When the fourth fluid (4-1-2) after the gas (4-1-1) has been separated from the fourth fluid (4-1) in the gas-liquid separation means 13, or the fourth fluid (4-1-4) that has not been vaporized in the vaporization means 14 are supplied into the water electrolysis means 15, they may be electrolyzed by mixing with contaminated water, etc., or only the fourth fluid (4-1-2) or only the fourth fluid (4-1-4) may be electrolyzed. By electrolyzing the fourth fluid (4-1-2) or the fourth fluid (4-1-4), it can be reused as the first fluid (1-1) used in the first separation device 10, or oxygen, which is the third fluid (3-2), used in the second separation device 20.

Note that the fourth fluid (4-1) flowing out from the cathode flow passage 113 of the first fuel cell 11 may be directly supplied into the water electrolysis means 15 without being subjected to gas-liquid separation to electrolysis.

The fourth fluid (4-1) flowing out from the cathode flow passage 113 of the first fuel cell 11 contains concentrated deuterium. Therefore, as described above, the fourth fluid (4-1) may be collected as water containing D₂O. The fourth fluid (4-1-2) after the gas-liquid separation in the gas-liquid separation means 13 or the fourth fluid (4-1-4) that has not vaporized in the vaporization means 14 may be collected as water containing D₂O.

In particular, it is preferable to collect the fourth fluid (4-1-2) after the gas (4-1-1) has been separated in the gas-liquid separation means 13 as water containing D₂O.

Further, deuterium can be further concentrated by returning a part of the second fluid (2-1) flowing out from the anode flow passage 112 of the first fuel cell 11 into the anode flow passage 112 of the first fuel cell 11 one or more times by the circulation means 12, or by returning a part of the fourth fluid (4-1-3) vaporized in the vaporization means 14 into the cathode flow passage 113 of the first fuel cell 11 one or more times.

### Separation in Second Separation Device

In the second separation device 20, first, at least a part of the second fluid (2-1) flowing out from the anode flow passage 112 of the first fuel cell 11 is flowed into the anode flow passage of the second fuel cell 21 of the second separation device 20 as the first fluid (2-1) through the first outflow passage 112b.

Separately, oxygen generated in the water electrolysis means 15 flows into the cathode flow passage of the second fuel cell 21 of the second separation device 20 as the third fluid (3-2) through the second inflow passage 213a.

A part of light hydrogen (H₂) and deuterium (D₂) contained in the first fluid (1-2) that has flowed into the anode flow passage of the second fuel cell 21 move from the anode flow passage in an ion state into the anode catalyst layer, and then further move from the anode catalyst layer into the cathode catalyst layer through the electrolyte membrane.

The light hydrogen ions and deuterium ions that have moved into the cathode catalyst layer of the second fuel cell 21 react with oxygen which is the third fluid (3-2) and has moved from the cathode flow passage into the cathode catalyst layer in the cathode catalyst layer and at the interface between the electrolyte membrane and the cathode catalyst layer, and produce water (H₂O and D₂O). The reaction at this time causes the electricity in the second fuel cell 21.

In this way, the second fluid (2-1) that has flowed out from the anode flow passage 112 of the first fuel cell 11 of the first separation device 10 is used for power generation and consumed.

The second fluid (2-2), which is a gas with a lower deuterium content than that of the first fluid (1-2) and which has not been used for power generation, flows out from the anode flow passage of the second fuel cell 21 through the first outflow passage 212b. The second fluid (2-2) that has flowed out may be discharged, or at least a part of the second fluid (2-2) can be returned into the anode flow passage in the second fuel cell 12 by the circulation means 12 provided in the second separation device 20. The method of returning is the same as that of the first separation device 10.

On the other hand, the water (H₂O and D₂O) which has been generated in the cathode catalyst layer and the like of the second fuel cell 21 and moved into the cathode flow passage flows out from the cathode flow passage of the second fuel cell 21 through the second, outflow passage 213b. The water (H₂O and D2₂O) which has flowed out from the cathode flow passage of the second fuel cell 21 and is the fourth fluid (4-2) may be supplied into the water electrolysis means 15, discharged or collected as water containing D₂O.

### Effect

According to the separation system and separation method of the present embodiment described above, in the first separation device, by flowing the third fluid (3-1), which is a gas containing water vapor instead of oxygen, into the cathode flow passage of the first fuel cell, the isotope exchange reaction results in HD+H₂O⇔H₂+HDO, and the separation coefficient for separating deuterium is improved. That is, deuterium can be separated as water containing deuterium from the fluid containing light hydrogen and deuterium (first fluid (1-1)). In addition, in the separation system and separation method of the present embodiment, since no electron exchange is performed in the first fuel cell, that is, the flow of electrons is blocked, no power is generated, H₂ consumption can be suppressed, and thereby deterioration of the separation system can also be suppressed.

Note that although the first separation device can separate deuterium from the fluid containing light hydrogen and deuterium (first fluid (1-1)) with high separation efficiency, the second separation device also separates deuterium as water containing deuterium from the fluid containing light hydrogen and deuterium (first fluid (1-2)) using power generation.

Therefore, the separation system and separation method of the present embodiment can separate deuterium from a fluid containing light hydrogen and deuterium with high separation efficiency while suppressing deterioration of the device.

### Other Embodiments

The separation system and separation method of the present invention are not limited to the embodiments described above.

For example, in the separation system 1 shown in FIG. 1, the first separation device 10 does not generate power, and only the second separation device 20 generates electricity. However, the first separation device 10 may also generate electricity. However, when electricity is generated in the first separation device 10, it is preferable that the amount of electricity generated in the first separation device 10 be smaller than the amount of electricity generated in the second separation device 20. By generating a small amount of electricity in the first separation device 10 as well, the deuterium separation efficiency is further increased. Furthermore, by making the amount of electricity generated in the first separation device 10 smaller than the amount of electricity generated in the second separation device 20, deterioration of the first separation device 10 can be suppressed.

In order to generate electricity in the first separation device 10, oxygen in addition to water vapor may be introduced into the anode flow passage 112 of the first fuel cell 11 as the third fluid (3-1). The water vapor and oxygen may be mixed and introduced into the anode flow passage 112 of the first fuel cell 11, or may be separately introduced into the anode flow passage 112 of the first fuel cell 11.

In addition, the separation system 1 shown in FIG. 1 includes the first separation device 10 and the second separation device 20 connected in series as two separation devices. However, the separation system may include the two first separation devices 10 connected in series.

Further, the separation system may include three or more separation devices connected in series. In this case, as long as at least the most upstream separation device among the three or more separation devices is the first separation device, all of the remaining separation devices may be the first separation devices, or one or more of the separation devices may be the second separation devices. In particular, it is preferable that at least the most downstream side be provided with the second separation device, and it is more preferable that only the most downstream portion be provided with the second separation device.

When the system includes a plurality of the separation devices connected together, the second fluid flowing out from the anode flow passage of the fuel cell provided in the previous separation device flows into the anode flow passage of the fuel cell provided in the separation device immediately after the previous separation device as the first fluid.

In a preferred embodiment of the separation system, when two separation devices are connected in series, a separation system is preferable in which the first separation device and the second separation device are provided in this order from the upstream side. When three or more separation devices are connected in series, a separation system is preferable in which two or more first separation devices and one second separation device are provided such that the second separation device is the most downstream.

### EXAMPLES

Hereinafter, the present invention will be specifically explained with reference to Examples, but the present invention is not limited thereto.

### Example 1

Using the separation system 1 shown in FIG. 1, deuterium was separated from a fluid containing light hydrogen and deuterium in the following manner.

A first fluid (1-1) containing 10 mol of light hydrogen (H₂) and 1 mol of deuterium (D₂) was flowed into the anode flow passage 112 of the first fuel cell 11 through the first inflow passage 112a.

Separately, water vapor generated in the humidifier 18 and N₂ was flowed into the cathode flow passage 113 of the first fuel cell 11 as the third fluid (3-1) through the second inflow passage 113a.

As shown in FIG. 2, a part of the light hydrogen (H₂) and deuterium (D₂) contained in the first fluid (1-1) that had flowed into the anode flow passage 112 moved from the anode flow passage 112 into the anode catalyst layer 111a, and further moved from the anode catalyst layer 111a into the cathode catalyst layer 111b through the electrolyte membrane 111.

The light hydrogen (H₂) and deuterium (D₂) that had moved into the cathode catalyst layer 111b underwent the isotope exchange reaction with the water vapor (H₂O) contained in the third fluid (3-1) that had moved from the cathode flow passage 113 into the cathode catalyst layer 111b in the cathode catalyst layer 111b and at the interface between the electrolyte membrane 111 and the cathode catalyst layer 111b, and produced D₂O and HDO.

Next, light hydrogen (H₂) and deuterium (D₂) contained in the first fluid (1-1) that had not moved into the cathode catalyst layer 111b were flowed out as the second fluid (2-1) from the anode flow passage 112 through the first outflow passage 112b. The second fluid contained 9 mol of light hydrogen (H₂) and 0.1 mol of deuterium (D₂).

Separately, the third fluid (3-1) that had not been used in the isotope exchange reaction and flowed through the cathode flow passage 113, and the D₂O, HDO, and H₂ that had been produced by the isotope exchange reaction and moved into the cathode flow passage 113 were flowed out as the fourth fluid (4-1) from the cathode flow passage 113 through the second outflow passage 113b. The fourth fluid (4-1) contained gaseous H₂O, H₂, and N₂, 1 mol of liquid H₂O, and 0.9 mol of D₂O.

Next, the fourth fluid (4-1) that had flowed out from the cathode flow passage 113 of the first fuel cell 11 was subjected to gas-liquid separation in the gas-liquid separator 13a of the gas-liquid separation means 13.

The gas (4-1-1) (H₂O, H₂ and N₂) that had been separated from the fourth fluid (4-1) flowed out from the gas-liquid separator 13a through the third outflow passage 13b and was discharged.

The fourth fluid (4-1-2) (1 mol of liquid H₂O and 0.9 mol of D₂O) after the gas (4-1-1) had been separated in the gas-liquid separation means 13 flowed out from the gas-liquid separator 13a through the fourth outflow passage 13c.

After the fourth fluid (4-1-2) from which the gas (4-1-1) had been separated in the gas-liquid separation means 13 was temporarily stored in the first tank 16 and the second tank 17, it was then supplied into the water electrolysis means 15 and electrolyzed. The light hydrogen (H₂) and deuterium (D₂) produced by the electrolysis were reused as the first fluid.

Separately, the second fluid (2-1) that had flowed out from the anode flow passage 112 of the first fuel cell 11 was flowed into the anode flow passage 112 of the second fuel cell 21 through the first outflow passage 112b as the first fluid (1-2).

Separately, oxygen generated in the water electrolysis means 15 was introduced as the third fluid (3-2) into the cathode flow passage of the second fuel cell 21 through the second inflow passage 213a.

A part of light hydrogen (H₂) and deuterium (D₂) contained in the first fluid (1-2) that had flowed into the anode flow passage of the second fuel cell 21 moved from the anode flow passage in an ion state into the anode catalyst layer 111a, and then moved from the anode catalyst layer 11a into the cathode catalyst layer 113 through the electrolyte membrane.

The light hydrogen ions and deuterium ions that had moved into the cathode catalyst layer of the second fuel cell 21 reacted with oxygen that had moved from the cathode flow passage into the cathode catalyst layer of the second fuel cell 21 in the cathode catalyst layer and at the interface between the electrolyte membrane and the cathode catalyst layer, then produced water (H₂O and D₂O) in the cathode catalyst layer. The reaction at this time caused electricity in the second fuel cell 21.

Next, light hydrogen (H₂) and deuterium (D₂) contained in the first fluid (1-2), which had not been used for electricity generation, flowed out as the second fluid (2-2) from the anode flow passage of the second fuel cell 21 through the first outflow passage 212b. The second fluid (2-2) contained 1 mol of light hydrogen (H₂) and 0.01 mol of deuterium (D₂).

Separately, the water (H₂O and D₂O) that had been generated in the cathode catalyst layer of the second fuel cell 21 moved into the cathode flow passage, and flowed out as the fourth fluid (4-2) from the cathode flow passage of the second fuel cell 21 through the second outflow passage 213b, and was discharged. This water contained 8 mol of liquid H₂O and 0.09 mol of D₂O.

From Example 1, it is clear that the fourth fluid (4-1) containing 1 mol of liquid H₂O and 0.9 mol of D₂O and the fourth fluid (4-2) containing 8 mol of liquid H₂O and 0.09 mol of D₂O could be obtained from the first fluid (1-1) containing 10 mol of light hydrogen (H₂) and 1 mol of deuterium (D₂), and deuterium could be separated with high separation efficiency.

EXPLANATION OF REFERENCE NUMBERALS

| | |
|---|---|
| 1 | separation system |
| 10 | first separation device |
| 11 | first fuel cell |
| 111 | electrolyte membrane |
| 111a | anode catalyst layer |
| 111b | cathode catalyst layer |
| 112 | anode flow passage |
| 112a | first inflow passage |
| 112b | first outflow passage |
| 113 | cathode flow passage |
| 113a | second inflow passage |
| 113b | second outflow passage |
| 12 | circulation means |
| 12a | first return flow passage |
| 12b | flow rate adjustment mechanism |
| 18 | humidifier |
| 20 | second separation device |
| 21 | second fuel cell |
| 212b | first outflow passage |
| 213a | second inflow passage |
| 213b | second outflow passage |

What is claimed is:

1. A separation system comprising a plurality of separation devices connected in series to separate deuterium from a fluid comprising at least light hydrogen and deuterium,
wherein each of the plurality of separation devices comprises an electrolyte membrane having an electrolyte;
wherein, of both sides of the electrolyte membrane, an anode catalyst layer and an anode flow passage are provided in this order on a first surface, and a cathode catalyst layer and a cathode flow passage are provided in this order on a second surface;
wherein a first inflow passage through which a first fluid that is a gas comprising at least light hydrogen and deuterium flows into the anode flow passage, and a first outflow passage through which a second fluid that is a gas having a lower deuterium content than that of the first fluid flows out from the anode flow passage are connected to the anode flow passage;
wherein a second inflow passage through which a third fluid flows into the cathode flow passage and a second outflow passage through which a fourth fluid comprising at least light water and heavy water flows out from the cathode flow passage are connected to the cathode flow passage; and
wherein, among the plurality of separation devices, a separation device provided at the most upstream side is a first separation device in which a gas comprising at least water vapor flows into the cathode flow passage as the third fluid, and third fluid that has passed through the cathode flow passage and deuterium that has moved from the anode catalyst layer into the cathode catalyst layer are discharged as the fourth fluid from the cathode flow passage.

2. The separation system according to claim 1,
wherein the first separation device includes a humidifier that generates the water vapor.

3. The separation system according to claim 1,
wherein in the first separation device, the third fluid that flows into the cathode flow passage further comprises nitrogen.

4. The separation system according to claim 1,
wherein the plurality of separation devices comprise one or more of the first separation devices, and one or more second separation devices which are different from the first separation device, and provided downstream of the first separation device;
wherein the first separation device does not generate electricity; and
wherein the second separation device generates electricity.

5. The separation system according to claim 1,
wherein at least one of the plurality of separation devices further comprises a circulation means;
wherein the circulation means comprises a first return flow passage that returns a part of the second fluid flowing out from the anode flow passage into the anode flow passage.

6. The separation system according to claim 1,
wherein the plurality of separation devices comprise one or more of the first separation devices, and one or more second separation devices which are different from the first separation device, and provided downstream of the first separation device; and
wherein an amount of electricity generated in the first separation device is smaller than an amount of electricity generated in the second separation device.

7. A separation method for separating deuterium from a fluid comprising at least light hydrogen and deuterium using a plurality of separation devices connected in series,
wherein each of the plurality of separation devices comprises an electrolyte membrane comprising an electrolyte;
wherein, of both sides of the electrolyte membrane, an anode catalyst layer and an anode flow passage are provided in this order on a first side, and a cathode catalyst layer and a cathode flow passage are provided in this order on a second side;
wherein a first fluid, which is a gas comprising at least light hydrogen and deuterium, flows into the anode flow passage, and a second fluid, which is a gas having a lower deuterium content than that of the first fluid, flows out from the anode flow passage;
wherein a third fluid flows into the cathode flow passage and a fourth fluid comprising at least light water and heavy water flows out from the cathode flow passage; and
wherein, among the plurality of separation devices, in a separation device provided at the most upstream side, a gas comprising at least water vapor flows into the cathode flow passage as the third fluid, and third fluid that has passed through the cathode flow passage and deuterium that has moved from the anode catalyst layer into the cathode catalyst layer are discharged as the fourth fluid from the cathode flow passage.
